(19) United States
(12) Patent Application Publication
(10) Pub. No.: US 2016/0028847 A1
(43) Pub. Date: Jan. 28, 2016

(54) ESTABLISHING CACHES THAT PROVIDE DYNAMIC, AUTHORITATIVE DNS RESPONSES

(71) Applicant: Microsoft Technology Licensing, LLC, Redmond, WA (US)

(72) Inventors: Gareth R. Bradshaw, Dublin (IE); Ashley Ryan Flavel, Seattle, WA (US); Kumar Ashutosh, Andhra Pradesh (IN); Jonathan Roshan Tuliani, Dublin (IE); Pradeepkumar Mani, Issaquah, WA (US); Tushar Gupta, Telangana (IN); Vithalprasad Jayendra Gaitonde, Hyderabad (IN); V R Kishore Chintalapati, Andhra Pradesh (IN); Benjamin J. Black, Sammamish, WA (US); William J. Griffin, Sammamish, WA (US); David A. Maltz, Bellevue, WA (US); Levon Hayrapetyan, Dublin (IE); Kresimir Bozic, Dublin (IE); Rajesh Kumar Maskara, Redmond, WA (US); Sourav Sain, Hyderabad (IN); Andrew Lientz, Bellevue, WA (US)

(73) Assignee: Microsoft Technology Licensing, LLC, Redmond, WA (US)

(21) Appl. No.: 14/339,097

(22) Filed: Jul. 23, 2014

(51) Int. Cl. H04L 29/08; H04L 29/12

(52) U.S. Cl. CPC H04L 67/2842; H04L 61/1511; H04L 61/6009

(57) ABSTRACT

Embodiments are directed to establishing caches that provide authoritative domain name system (DNS) answers to DNS requests. In one scenario, a computer system establishes a cache that stores authoritative DNS answers to DNS queries. The cache corresponds to a specified DNS zone that includes authoritative DNS answers for a subset of DNS queries. The cache is configured to store the authoritative DNS answers for at least a specified period of time during which the authoritative DNS answers are updatable. The cache then receives an update indicating that at least one cached DNS answer is out-of-date and the computer system purges the out-of-date DNS answer from the cache, ensuring that the cache continually provides authoritative DNS answers for DNS queries assigned to the specified DNS zone.

### BACKGROUND

The internet comprises a vast network of interconnected computing systems. These computing systems typically interact with each other using unique internet protocol (IP) addresses that allow computing systems to identify each another. IP addresses, however, are long and cumbersome to remember. Moreover, the IP addresses bear no relation to the site or service being accessed and may change without notice. As such, the domain name system (DNS) was established by which web site owners can link a common domain name (e.g. Wikipedia.org) to an IP address (or set of IP addresses). DNS servers receive requests for certain domain names, and those DNS servers provide replies with the IP address corresponding to that domain name. In daily operation, DNS servers typically receive repeated requests for a certain subset of domain names. Answers to these DNS requests can be cached for some period of time, but go stale as soon as the DNS time-to-live (TTL) expires.

### BRIEF SUMMARY

Embodiments described herein are directed to providing authoritative domain name system (DNS) answers to DNS requests and to establishing caches that provide authoritative DNS answers to DNS requests. In one embodiment, a computer system establishes a cache that stores authoritative DNS answers to DNS queries. The cache corresponds to a specified DNS zone that contains authoritative DNS answers for a subset of DNS queries. The cache is configured to store the authoritative DNS answers for at least a specified period of time during which the authoritative DNS answers are updatable. The cache then receives an update indicating that at least one cached DNS answer is out-of-date and the computer system purges the out-of-date DNS answer from the cache, ensuring that the cache continually provides authoritative, dynamic DNS answers for DNS queries assigned to the specified DNS zone.

In another embodiment, a computer system dynamically provides authoritative DNS answers to DNS requests. To enable equivalent DNS queries to a specified DNS zone to receive different responses, various versions of the DNS zone are created, referred to herein as “zone scopes”. Each zone scope has in turn a corresponding “cache scope” that caches DNS answers for that zone scope. The computer system determines, based on various factors, which zone scope is to handle a received DNS request. Each zone scope includes at least one cache scope that stores authoritative DNS answers for a subset of DNS requests. The computer system then accesses at least one authoritative DNS answer stored in the cache scope of the determined zone scope, and provides the accessed authoritative DNS answer from the accessed cache scope.

In yet another embodiment, a computer system determines, based on various factors, which cache scope is to handle a received DNS request. Each cache scope corresponds to a DNS zone scope that is authorized to provide authoritative DNS answers for a subset of DNS requests. The computer system then determines that a specified DNS answer is not stored within the determined cache scope and sends a request for the most current DNS answer, where the request includes an indication of the DNS zone scope that was determined to provide an authoritative DNS answer for the received DNS request. Then, upon receiving the updated DNS answer for the determined DNS zone, the computer system providing the received DNS answer to the DNS request.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including establishing caches that provide authoritative domain name system (DNS) answers to DNS requests.

FIG. 2 illustrates a flowchart of an example method for establishing caches that provide authoritative domain name system (DNS) answers to DNS requests.

FIG. 3 illustrates a flowchart of an example method for dynamically providing authoritative DNS answers to DNS requests.

FIG. 4 illustrates a flowchart of an alternative example method for dynamically providing authoritative DNS answers to DNS requests.

FIG. 5 illustrates a computing architecture in which DNS traffic management may be performed on a DNS edge server.

### DETAILED DESCRIPTION

Embodiments described herein are directed to establishing caches that provide authoritative domain name system (DNS) answers to DNS requests. In one embodiment, a computer system establishes a cache that stores authoritative DNS answers to DNS queries. The cache corresponds to a specified DNS zone that is contains authoritative DNS answers for a subset of DNS queries. The cache is configured to store the authoritative DNS answers for at least a specified period of time during which the authoritative DNS answers are updatable. The cache then receives an update indicating that at least one cached DNS answer is out-of-date and the computer system purges the out-of-date DNS answer from the cache, ensuring that the cache continually provides authoritative DNS answers for DNS queries assigned to the specified DNS zone.

In another embodiment, a computer system dynamically provides authoritative DNS answers to DNS requests. The computer system determines, based on various factors, which zone scope is to handle a received DNS request. Each zone scope includes at least one cache scope that stores authoritative DNS answers for a subset of DNS requests. The computer system then accesses at least one authoritative DNS answer stored in the cache scope of the determined zone scope, and provides the accessed authoritative DNS answer from the accessed cache scope.

In yet another embodiment, a computer system determines, based on various factors, which cache scope is to handle a received DNS request. Each cache scope corresponds to a DNS zone scope that is authorized to provide authoritative DNS answers for a subset of DNS requests. The computer system then determines that a specified DNS answer is not stored within the determined cache scope and sends a request for the most current DNS answer, where the request includes an indication of the DNS zone scope that was determined to provide an authoritative DNS answer for the received DNS request. Then, upon receiving the updated DNS answer for the determined DNS zone, the computer system provides the received DNS answer to the DNS request and caches the received DNS answer for future queries.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. Virtual machines may also operate on and implement the hardware of any such computing system to perform computational tasks. A computing system may be distributed over a network environment and may include multiple constituent computing systems.

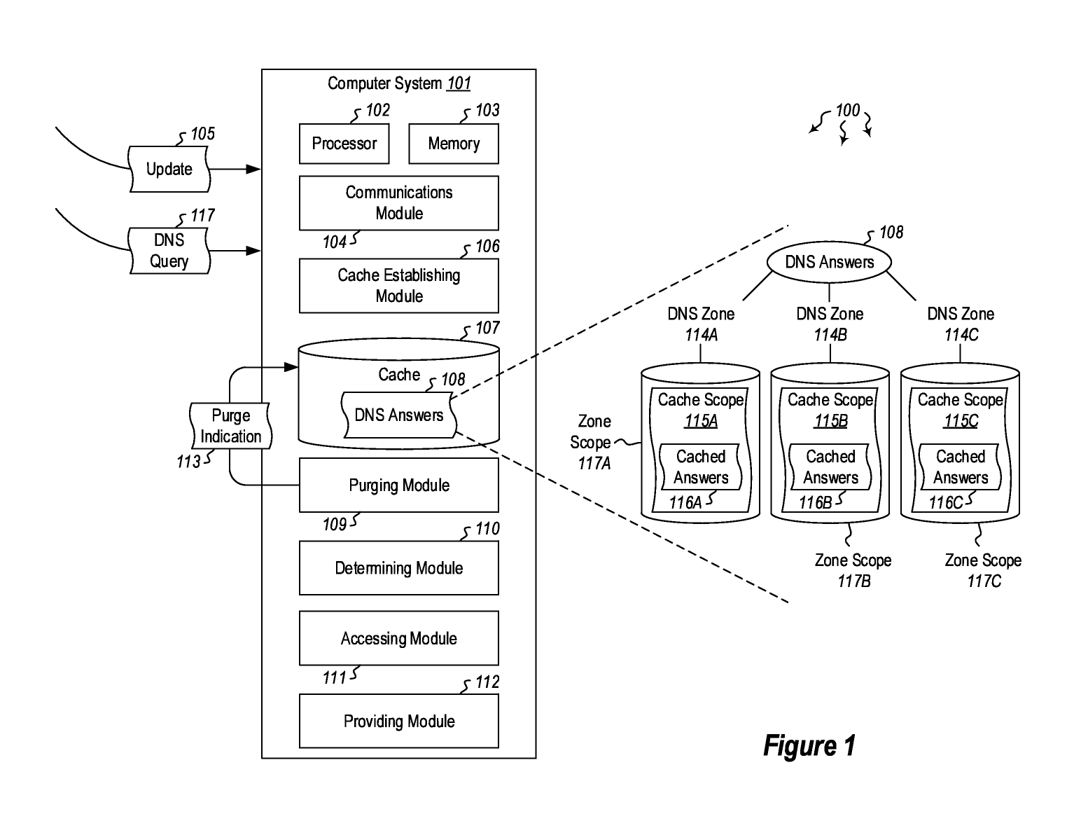

As illustrated in FIG. 1, a computing system 101 typically includes at least one processing unit 102 and memory 103. The memory 103 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 103 of the computing system 101. Computing system 101 may also contain communication channels that allow the computing system 101 to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which at least one embodiment may be employed. Computer architecture 100 includes computer system 101. Computer system 101 may be any type of local or distributed computer system, including a cloud computing system. The computer system 101 includes modules for performing a variety of different functions. For instance, the communications module 104 may be configured to communicate with other computing systems. The computing module 104 may include any wired or wireless communication means that can receive and/or transmit data to or from other computing systems. The communications module 104 may be configured to interact with databases, mobile computing devices (such as mobile phones or tablets), embedded or other types of computing systems.

The computer system 101 further includes a cache establishing module 106. The cache establishing module 106 may be configured to establish cache 107 that is configured to store DNS answers 108 to DNS queries 117. The DNS queries may be requesting an IP address, Canonical Name Record (CNAME), Mail Exchanger (MX) record, or other record or address associated with a specified DNS name. The DNS answers 108 may represent a sum of all (or at least a subset) of the available answers to a DNS query. These DNS answers 108 (or different versions of the DNS answers) may be broken up and distributed over a plurality of different zones scopes.

As mentioned above, each DNS zone may be divided up into different zone versions or “zone scopes” as the term is used herein. Each DNS zone may include substantially any number of zone scopes. Thus, while each DNS zone in FIG. 1 is shown with one zone scope, it will be understood that each DNS zone may have any number of different zone scopes. Each zone scope may have a corresponding cache scope (e.g. zone scope 117A has corresponding cache scope 115A, 117B has 115B, 117C has 115C, and so on) that is a cache or data store for the DNS answers that are within that zone scope. DNS zones may be defined geographically, by time zone, by name, by language or by any other means of defining a zone. In embodiments where the zones are defined geographically, various localized or “edge” servers may be set up in various geographically dispersed areas.

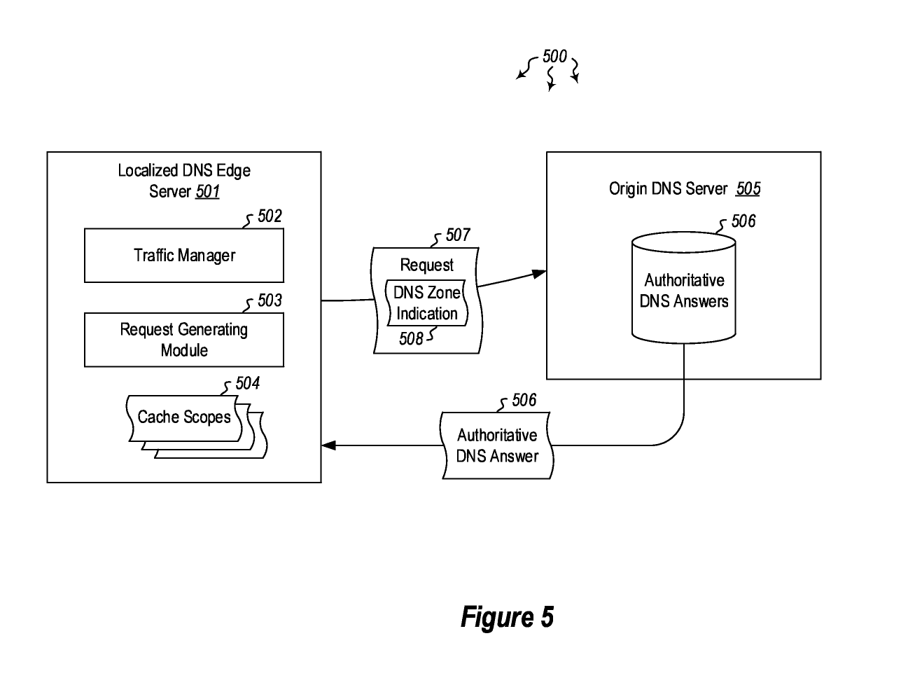

For example, in many cases, requests for DNS translations (from domain name to IP address) are localized in nature. People from the United States tend to request websites that are based in the United States, people from China tend to request websites that are based in China, and so on. Obviously, users are free to enter URLs for any website into a browser, but for the purposes of caching DNS answers to repeated requests, it may be generally assumed that repeated requests for certain websites will be localized to certain regions. As such, as shown generally in FIG. 5, DNS edge servers or localized DNS servers (e.g. 501) may be established all over the world in different regions. The edge DNS servers may be localized servers, and may number in the hundreds, thousands or more. These DNS edge servers may be in communication with origin or master DNS servers that store authoritative DNS answers 506. For example, origin DNS server 505 may store authoritative DNS answers 506 which are the world-wide, accepted, authoritative answers for DNS queries. They serve as the source or origin for updated DNS translations. These authoritative DNS answers 509 may be sent to the various DNS edge servers 501 on a periodic basis or on demand when requested.

In a traditional DNS implementations, DNS data is stored on the Internet-facing servers. As a result, the Internet-facing servers are partitioned when the data volume gets too big (e.g. millions of zones). One problem with partitioning is that it also partitions a system's capacity to absorb a distributed denial of service (DDoS) attack. In embodiments described herein, In the cache-based design, an origin DNS server can be partitioned to provide horizontal scale, without partitioning the edge DNS server, which talks to all origins. The edge DNS server does not need to cache all records; rather it can cache as many as its memory permits. The edge DNS server therefore does not need to be partitioned, providing undivided capacity to better absorb DDoS attacks.

Still further, in traditional DNS implementations, DNS record changes are propagated to all edge DNS server locations, which may be hundreds of servers (or more). This can take a large amount of time, during which dependent systems have to wait. For example, a customer may be waiting for a storage account and its DNS entry to be created before they can use the account. In embodiments described herein, new records only need to be propagated to the origin DNS server, and will then be available to be served from the edge DNS server immediately if/when a corresponding query arrives. It should be noted that, at least in some cases, this only applies to new records—modified or deleted records are actively purged from the edge server cache—however, waiting to change or delete records is a less common scenario.

Returning to FIG. 1, the DNS answers 108 may be divided into different geographic or other DNS zones (e.g. 114A, 114B or 114C). Each DNS zone may have a corresponding cache scope (115A, 115B or 115C, respectively) that stores cached DNS answers (116A, 116B or 116C, respectively) for that zone. The cached DNS answers may be stored for substantially any length of time, and may be valid for much longer than the specified time-to-live (TTL). In embodiments described herein, cached DNS answers may be valid and authoritative for many hours, days or longer. The purging module 109 of computer system 101 looks for DNS answers that are out-of-date and purges those that are determined to be out-of-date.

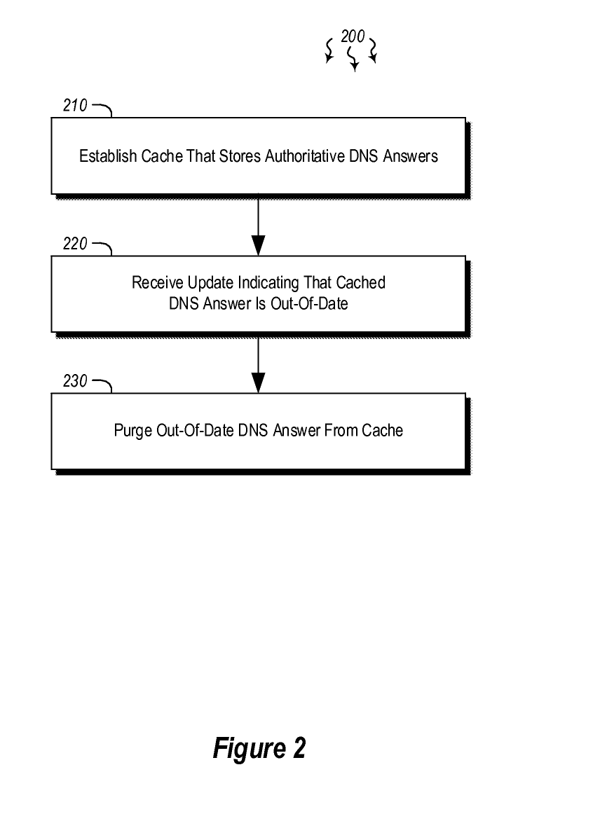

In some cases, the computer system 101 may receive an update 105 (which could be pulled or pushed) from an origin server or from another source indicating that one or more specified DNS answers are expired or no longer valid (i.e. “stale”). In such cases, the one or more specified DNS answers would be purged from the cache 107. It should be noted here that the cache 107 may represent any one or more of the cache scopes 115A, 115B, 115C or other cache scopes. Indeed, each cache scope may cache different DNS answers, depending on the corresponding DNS zone (whether it is defined geographically or otherwise). As such, the purging module 109 may purge those cache scopes where the DNS answers are cached and perform no action on cache scopes that do not contain the stale DNS answers. The purging and updating of DNS answers will be explained further below with regard to methods 200, 300 and 400 of FIGS. 2, 3 and 4, respectively.

In embodiments described herein, edge or localized DNS servers may be configured to handle the majority of the request processing load by caching DNS responses issued by and/or received from an origin or source DNS server. Localized DNS servers may be configured to act as permanent (or at least long-term) caches by ignoring or overriding the DNS answer's assigned TTL. Moreover, the localized edge servers may be configured to serve authoritative, cached responses. As such, the localized edge servers may look and act as a massive unified DNS service. To support continual, quick updates, rather than using a short TTL, the origin DNS server has a back-channel to each edge DNS server to communicate DNS answers that are out-of-date and to indicate that those cache entries are to be purged.

In some embodiments, DNS security extensions (DNSSEC) may be used to digitally sign DNS answers. In such cases, dynamic signing of responses (even negative responses) may create a performance bottleneck, especially if under a denial of service (DDoS) attack. In embodiments herein, each possible response is considered to be part of a separate DNS zone or view of the DNS answers 108, and each DNS zone may be pre-signed (i.e. signed on startup with incremental signing for zone changes). This allows DNS answers to be served quickly and further allows for traffic management to be implemented by having a traffic management engine determine which DNS zone to serve the response from as opposed to having the traffic management engine dynamically generate the response itself. Moreover, in these embodiments, DNSSEC signing keys are not exposed on internet-facing servers.

The localized DNS servers are thus configured to serve the actual DNS responses, and may offset load from the origin or source DNS server by using long-term caching. The caching is performed in a way that maintains traffic management capabilities to provide different DNS responses to different queries, so that the clients making those queries can then make connections to different systems, for failover, performance or load-distribution or other reasons. The localized edge DNS servers maintain a set of cache scopes (one per DNS zone) and the logic of the traffic management engine is performed on the edge DNS server. The traffic management engine in the edge DNS server determines which zone scope the response is to come from and this in turn dictates which cache scope the cached response should be served from.

The use of scopes (cache and zone) enables traffic management. Each possible DNS answer is stored in a (potentially different) cache scope. At least in some embodiments, zone scopes are defined on an origin DNS server and records corresponding to those zone scopes are cached at the edge DNS servers. As a query is received, the edge DNS server determines which zone scope is to respond to the query (e.g. based on rules or policies). The edge DNS server then serves the appropriate response from the local cache scope or calls the appropriate Origin DNS server specifying the appropriate scope in the event of a cache miss.

For instance, if the traffic management engine determines that a DNS answer is to come from DNS zone 114A, the response will be provided from the cached DNS answers 116A in cache scope 115A. If the appropriate DNS answer is not contained in the cache scope (a cache-miss), an origin or source DNS server will be queried for an authoritative DNS answer which is then cached in the corresponding cache scope (115A in the example above). As the edge DNS server is performing traffic management, an indication of the determined DNS zone (114A in the above example) is communicated to the origin DNS server so that it can respond from the correct DNS zone. The indication of DNS zone may be communicated using metadata in a DNS extension (e.g. a EDNSO extension). These concepts will be explained further below with regard to methods 200, 300 and 400 of FIGS. 2, 3 and 4, respectively.

In view of the systems and architectures described above, methodologies that may be implemented in accordance with the disclosed subject matter will be better appreciated with reference to the flow charts of FIGS. 2, 3 and 4. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for establishing caches that provide authoritative domain name system (DNS) answers to DNS requests. The method 200 will now be described with frequent reference to the components and data of environment 100.

Method 200 includes an act of establishing a cache that stores authoritative DNS answers to DNS queries, the cache corresponding to at least one specified DNS zone scope that is includes authoritative DNS answers for a subset of DNS queries, the cache being configured to store the authoritative DNS answers for at least a specified period of time during which the authoritative DNS answers are updatable (act 210). For example, cache establishing module 106 may establish cache 107 that stores authoritative DNS answers 108 to DNS queries 117. As mentioned above, the cache 107 may correspond to a particular DNS zone and may be referred to as a cache scope, as it caches those DNS answers that are within the scope of the associated DNS zone. Thus, cache scope 115A includes those cached answers 116A that correspond to or are within DNS zone 114A, and so on for other cache scopes 115B, 115C and others. Thus, cache 107 may represent multiple different cache scopes or may, itself, be a single cache scope.

Each cache scope may be configured to store the cached answers (e.g. 116A) for a specified amount of time. This amount of time may be configurable and variable, and may be different for each DNS answer, each DNS zone or each cache scope. This specified period of time for the cache to store the authoritative DNS answers may be different than a TTL that is associated with a DNS answer. The specified time may override or replace the time specified in the TTL designation. As such, the cached answer may have a much longer life than a normal DNS answer. In some embodiments, the specified time may also be a TTL that is set to automatically expire after a set time. Alternatively, a DNS answer may be created such that it will not expire until purged.

In some embodiments, the cache establishing module 106 may establish multiple caches that each correspond to different DNS zones. The cache establishing module 106 may further establish a default cache that is configured to store a specified subset of DNS answers (or DNS answer versions). This subset of DNS answers may be negative answers to DNS queries. Thus, if a user or computer system requests a DNS translation and the domain name does not exist or otherwise does not translate to a valid destination address, the default cache may send out a negative reply indicating that the DNS domain name does not exist. This negative reply may be digitally signed and may be pre-signed before being cached in the default cache. As such, the pre-signed negative DNS answers may be sent without having to expend or plan processing resources to digitally sign the reply in real-time.

Each of the caches or cache scopes may be stored redundantly and may be geographically dispersed throughout the world. This allows the caches to be used in traffic shaping. In traffic shaping or load balancing, responses to incoming requests are intelligently routed to certain DNS zone scopes. In some cases, the traffic shaping may determine which DNS zone scope is to provide a DNS answer. In this manner, DNS answers are dynamically provided by different zone scopes depending on which zone scope has the DNS answer stored in its corresponding cache scope.

Returning to FIG. 2, method 200 includes an act of receiving, at the cache, an update indicating that at least one cached DNS answer is out-of-date (act 220). For example, communications module 104 of computer system 101 may receive an update 105 indicating that at least one of the cached DNS answers 108 (in at least one cache scope) is out-of-date and needs to be purged. The update may come from an origin server or from some other source. The communications module 104 may pass the update on to the cache and/or the purging module 109 to initiate the purging of the old, out-of-date DNS answer. Such updates may be received on a periodic basis and may be received as the result of a request, or may be received as a push notification or may be received during synchronous communication with an origin server or other computer system. The update 105 may specify one out-of-date DNS answer or many and may specify the stale entries individually or as groups (perhaps by domain). In some cases, the update may also include an updated DNS answer which replaces the purged, out-of-date DNS answer. This DNS answer is cached and applied to subsequent similar requests.

Method 200 further includes an act of purging the out-of-date DNS answer from the cache, ensuring that the cache continually provides authoritative DNS answers for DNS queries assigned to the specified DNS zone (act 230). The purging module 109 of computer system 101 may generate a purge indication 113 in response to the update 105. The purge indication indicates to the cache 107 that a specified list of DNS answers have gone stale and are no longer valid. These DNS answers are to be purged from the cache and new entries are to be requested from the origin DNS server. As such, instead of implementing short TTLs with DNS answers, long-term, authoritative answers may be stored in caches and provided to users as authoritative DNS answers until the cache receives a purge indication 113 or until a specified time has passed (normally much longer than the normal TTL).

Some or all of the DNS answers provided by the various cache scopes (e.g. 115A-C) may be digitally pre-signed. As such, DNS answers do not need to be signed on-the-fly (typically using DNSSEC). The digital signatures associated with each pre-signed DNS answer may similarly expire when a purge indication 113 is generated or when a specified amount of time has expired. Still further, traffic managers may be implemented with the pre-signed DNS answers. The DNS queries may be assigned to various DNS zone scopes by a traffic manager. The traffic manager determines which DNS zone scope is to provide an authoritative DNS answer for each received DNS request. As shown in FIG. 5, this traffic manager 502 may be located on a localized edge DNS server 501 or on some other computer system. Thus, a traffic manager on an edge server may determine not which DNS answer to give but which zone scope (i.e. which cache scope) to get the stored answer from. If another user sends the same DNS query, the traffic manager 502 may route the request to the same cache scope which will provide the authoritative, cached DNS answer.

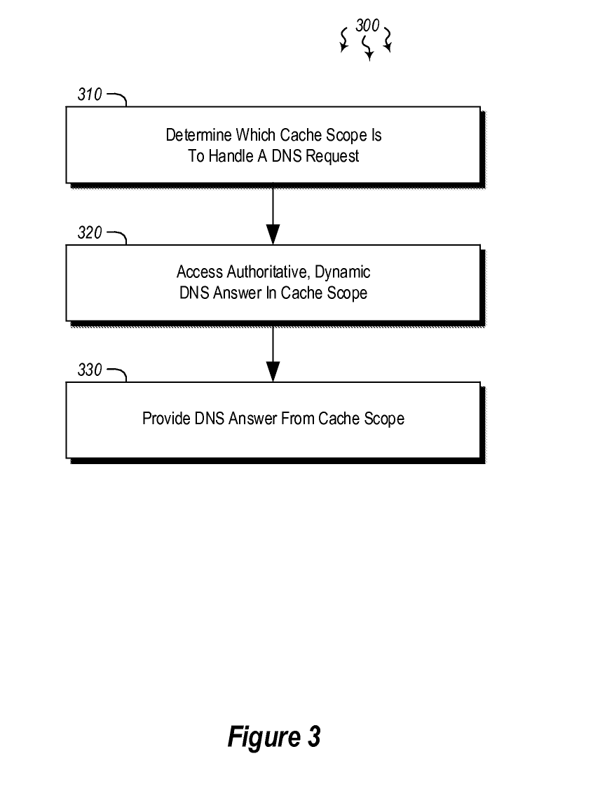

Turning now to FIG. 3, a flowchart is provided of a method 300 for dynamically providing authoritative DNS answers to DNS requests. The method 300 will now be described with frequent reference to the components and data of environment 100.

Method 300 includes an act of determining, based on one or more factors, which of a plurality of zone scopes is to handle a received DNS request, each zone scope including at least one cache scope that stores authoritative DNS answers for a subset of DNS requests (act 310). As outlined above, DNS answers 108 may represent all (or at least a subset) of the possible DNS responses for DNS requests worldwide. In various regions, repeated DNS requests (suited for caching) are received for a certain subset of the available websites, and tend to follow geographic or language-based patterns. German users request German websites more often than Japanese users do, Japanese users request Japanese websites more often than Indians do, and so on. As such, the group of possible DNS answers 108 may be divided into DNS zones (e.g. 114C), each with one or more zone scopes (e.g. 117C), each zone scope having its own cache scope (e.g. 115C). This cache scope includes cached DNS answers (e.g. 116C) assigned to that DNS zone scope. In this manner, each cache scope may include cached DNS answers for those domain names that are most frequently requested in a particular region.

The determining module 110 may determine, based on factors including the origin of the DNS request, the time the request was received, the domain that was requested, the device or device type the request was received from or any of a variety of other factors, which DNS zone scope (and therefore which cache scope) is to handle the DNS request. Once a DNS zone scope has been determined (e.g. 117B), that DNS zone scope's corresponding cache scope may provide the DNS answer from the cached answers (e.g. 116B). The accessing module 111 of computer system 101 accesses at least one authoritative DNS answer stored in the cache scope of the determined zone scope (act 320), and the providing module 112 provides the authoritative DNS answer from the accessed cache scope (act 330). This DNS answer may be provided to a user, to an internet browser, to a specified device or to some other location.

In some embodiments, the DNS answers are dynamically provided in a traffic-managed domain. In such a traffic-managed domain, DNS requests are to be answered by specific DNS zone scopes based on certain factors including which DNS zone scope is known to have a cached answer, which zone scope is able to handle additional requests, which zone scope is best suited to respond to a certain request or type of request, etc. The traffic-managed domains may have multiple different traffic managers, where each traffic manager is configured to communicate with the other traffic managers, and where each traffic manager includes a profile. The traffic managers thus work together to perform load balancing or other forms of traffic shaping on incoming DNS requests.

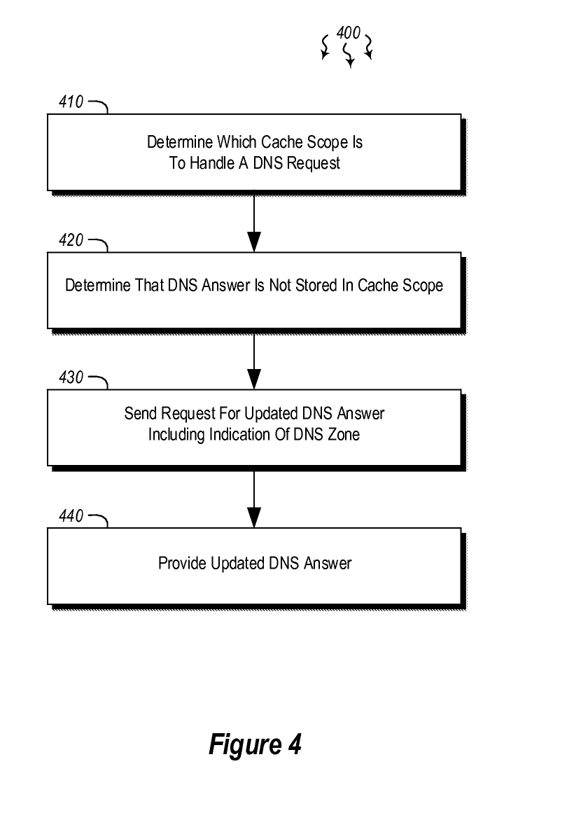

FIG. 4 illustrates a flowchart of a method 400 for dynamically providing authoritative DNS answers to DNS requests. The method 400 will now be described with frequent reference to the components and data of environment 100 of FIG. 1 and environment 500 of FIG. 5.

Method 400 includes an act of determining, based on one or more factors, which of a plurality of zone scopes is to handle a received DNS request, each zone scope including at least one cache scope that stores authoritative DNS answers for a subset of DNS requests (act 410). The determining module 110 of computer system 101 may determine which DNS zone scope (e.g. 117A) and, hence, which cache scope (e.g. 115A) is to handle a specified DNS query (e.g. 117). The determining module 110 may further determine that the specified DNS answer is not stored within the cache scope of the determined zone scope (act 420). For example, the determining module 110 may determine that zone scope 117A is to handle the received DNS request and may further determine that cache scope 115A does not have that specific DNS answer or the cached answer it does have is no longer valid.

Method 400 further includes an act of sending a request for a current, updated DNS answer, the request including an indication of the DNS zone scope that was determined to provide an authoritative DNS answer for the received DNS request (act 430). For example, as shown in FIG. 5, the request generating module 503 may generate request 507 which requests an updated DNS answer from the origin DNS server 505. The request 507 includes an indication 508 of which DNS zone/which cache scope the DNS answer was identified by the determining module 110. The indication may be included in DNS extension metadata or in other data. This enables the origin DNS server 505 to provide an authoritative DNS answer 506 for the cached scope (e.g. 504) that was originally to provide the DNS answer. Then, upon receiving the updated DNS answer for the determined DNS zone, the providing module 112 of computer system 101 provides the updated DNS answer 506 to the received DNS request (act 440).

The cache scopes may be updated on-demand (e.g. as requests are received) in this manner. Additionally or alternatively, the cache scopes may be continually updated in the background as DNS answers change at the origin DNS server. The origin DNS server 505 may communicate the DNS answer changes in updates 105, as explained above. These changes may cause the purging module 109 to automatically purge the out-of-date DNS answers. In this manner, out-of-date DNS answers are purged from the cache scopes, ensuring that the various cache scopes continually provide authoritative DNS answers for DNS queries assigned to the specified DNS zones.

Accordingly, methods, systems and computer program products are provided which establish caches that provide authoritative domain name system (DNS) answers to DNS requests. Moreover, methods, systems and computer program products are described which dynamically provide authoritative DNS answers to DNS requests.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. At a computer system including at least one processor, a computer-implemented method for establishing caches that provide authoritative domain name system (DNS) answers to DNS requests, the method comprising:
an act of establishing a cache that stores authoritative DNS answers to DNS queries, the cache corresponding to at least one specified DNS zone scope that includes authoritative DNS answers for a subset of DNS queries, the cache being configured to store the authoritative DNS answers for at least a specified period of time during which the authoritative DNS answers are updatable;
an act of receiving, at the cache, an update indicating that at least one cached DNS answer is out-of-date; and
an act of purging the out-of-date DNS answer from the cache, ensuring that the cache continually provides authoritative DNS answers for DNS queries assigned to the specified DNS zone.

2. The method of claim 1, wherein the specified period of time for the cache to store the authoritative DNS answers is configurable for each DNS answer.

3. The method of claim 1, wherein the specified period of time for the cache to store the authoritative DNS answers is different than a time specified by a time-to-live (TTL) designation in the DNS answer, such that the specified period of time overrides the time specified by the TTL designation.

4. The method of claim 1, wherein a plurality of caches is established including at least a first cache corresponding to a first specified DNS zone, and a second, default cache configured to store a specified subset of DNS answers.

5. The method of claim 4, wherein the second, default cache is configured to store negative DNS answers indicating that the DNS name does not exist.

6. The method of claim 4, wherein purging the out-of-date DNS answer from the cache further comprises replacing the purged out-of-date DNS answer with and updated DNS answer provided with the received update.

7. The method of claim 1, wherein the DNS zone covers a specified geographical area, such that DNS requests received from that geographical area will be answered by the DNS zone specified for that geographical area.

8. The method of claim 7, wherein the computer system provides DNS service for a plurality of DNS zones, each DNS zone having a corresponding cache.

9. The method of claim 1, wherein at least one of the DNS answers provided by the cache is digitally pre-signed.

10. At a computer system including at least one processor, a computer-implemented method for dynamically providing authoritative DNS answers to DNS requests, the method comprising:
an act of determining, based on one or more factors, which of a plurality of zone scopes is to handle a received DNS request, each zone scope including at least one cache scope that stores authoritative DNS answers for a subset of DNS requests;
an act of accessing at least one authoritative DNS answer stored in the cache scope of the determined zone scope; and
an act of providing the accessed authoritative DNS answer from the accessed cache scope.

11. The method of claim 10, wherein the authoritative DNS answers are provided in a traffic-managed domain.

12. The method of claim 11, wherein the traffic-managed domain has a plurality of traffic managers, each traffic manager including a profile.

13. The method of claim 12, wherein the traffic managers perform load balancing over different zone scopes, such that different zone scopes provide authoritative DNS answers for equivalent queries.

14. The method of claim 12, wherein the traffic managers answer subsequent DNS requests for the same DNS name from the established cache.

15. The method of claim 10, wherein the cache scope is continually updated as DNS answers change at the origin.

16. A computer system comprising the following:
one or more processors;
one or more computer-readable storage media having stored thereon computer-executable instructions that, when executed by the one or more processors, cause the computing system to perform a method for dynamically providing authoritative DNS answers to DNS requests, the method comprising the following:
an act of determining, based on one or more factors, which of a plurality of zone scopes is to handle a received DNS request, each zone scope including at least one cache scope that stores authoritative DNS answers for a subset of DNS requests;
an act of determining that a specified DNS answer is not stored within the cache scope of the determined zone scope;
an act of sending a request for a current DNS answer, the request including an indication of the DNS zone scope that was determined to provide an authoritative DNS answer for the received DNS request; and
upon receiving the updated DNS answer for the determined DNS zone scope, an act of providing the received DNS answer to the DNS request.

17. The computer system of claim 16, wherein the indication of the specified DNS zone scope that was authorized to provide an authoritative DNS answer for the received DNS request is included in DNS extension metadata.

18. The computer system of claim 16, further comprising caching the received DNS answer for subsequent queries.

19. The computer system of claim 16, wherein out-of-date DNS answers are purged from the cache scopes, ensuring that the cache scopes continually provide authoritative DNS answers for DNS queries assigned to the specified DNS zone scopes.

20. The computer system of claim 16, wherein the received, updated DNS answer for the determined DNS zone scope includes a DNS answer update that overwrites the current DNS answer.
